(19) United States
(12) Patent Application Publication
(10) Pub. No.: US 2012/0224678 A1
(43) Pub. Date: Sep. 6, 2012

(54) MONITORING INMATE CALLS USING SILENCE RECOGNITION SOFTWARE TO DETECT UNAUTHORIZED CALL CONNECTING

(76) Inventors: Jay Walters, Hallsville, TX (US); Randy L. Reeves, Gladewater, TX (US)

(21) Appl. No.: 13/037,865

(22) Filed: Mar. 1, 2011

(51) Int. Cl. H04M 3/00

(52) U.S. Cl. 379/189

(57) ABSTRACT

A system and method for managing and controlling telephone activity in a correctional facility comprises providing a first communicative connection between a caller and a recipient, delivering the conversation between the caller and the recipient over the first communicative connection and executing silence recognition software to identify a plurality of periods of conversation silence delivered over the first communicative connection. By comparing the periods of conversation silence with a silence threshold, a determination can be made as to whether the recipient is attempting to create an unauthorized call connection. Based on that comparison step, a detection response is executed.

### BACKGROUND

The present invention generally relates to telecommunications monitoring and, more specifically, to a system and method for monitoring phone calls to and from an inmate within a correctional facility through the use of speech and voice recognition software in order to detect unauthorized call connecting.

There exists a need to control and monitor access to telephone lines in a correctional facility, such as a prison or jail. By and large, such control and monitoring systems are implemented for security considerations. One such security concern is an inmate's attempt to place threatening or harassing phone calls to certain individuals. An early solution to this problem was to limit the inmate's phone access to only allow the inmate to place collect calls in the hope that forcing the inmate to provide his/her identity would give the call recipient an opportunity to deny the call. However, such a solution does not effectively address the issue, as inmates can easily provide a false identity hoping that the recipient will accept the collect call.

The problem of an inmate placing threatening or harassing phone calls is further complicated by the fact that the inmate callers often work in concert with individuals outside of the correctional facility. For example, the inmate may have a restraining order against a certain individual and is not allowed to contact that individual in any way, including by phone. However, the inmate may contact a friend of that individual who then sets up a 3-way call with or call forwarding to the individual, thereby allowing the inmate to have an unlawful conversation with the individual. Though the 3-way call or call forwarding may be prohibited by law, it is difficult for the correctional institution to prevent it because the inmate's phone call to the friend is lawful and the friend has unrestricted telephone access. Therefore, the friend's ability to set up 3-way phone calls and/or call forwarding to bridge telephone connections essentially provides the inmate with unrestricted telephone access.

There are a variety of known attempts to solve the problem of unauthorized inmate telephone call connecting. In the context of call bridging, one common solution is to detect the hook flash signal produced when such call bridging is attempted. Pursuant to one known solution, a detection apparatus includes a low pass band filter for passing energy having frequencies below a certain frequency and an energy detector for detecting a specific electrical energy pulse having been filtered by the low pass filter. Therefore, the detection apparatus is dependent upon the analog signals generated during the call bridging attempt. Another known solution detects the presence of certain tones within the telephone signal, such as dual tone multifrequency tones, special information tones, dial tones, and other call progress tones. The identification of these analog tones is used to determine if an attempted call bridging has taken place.

As shown through the above discussion, the prior art solutions have been singularly focused on the identification of attempted phone call connecting in the context of standard, analog telephone systems. However, like all technologies, the way people send and receive phone calls is continuing to evolve. More and more companies and individuals are utilizing voice over internet protocol (VoIP) services. VoIP is a general term for a range of communication transmission technologies designed to deliver voice and other forms of communication over IP networks, such as the internet or other packet-switched networks, as opposed to the public switched telephone network (PSTN). Because of the bandwidth efficiency and low costs that VoIP technology can provide, businesses and other institutions (such as correctional facilities) are beginning to utilize VoIP services in place of their traditional copper-wire telephone systems.

In order to allow the voice communications to be transferred over an IP network, the voice communications are converted from an analog signal into a digital format. As a result, the communications transferred and delivered over VoIP do not contain many of the same signals and tones utilized by the prior art systems to detect attempted phone call connecting. Therefore, known systems would be unable to detect inmate call connecting in a VoIP delivery context.

Therefore, there is a need for a system and method for detecting attempted and unauthorized call connecting for inmate communications delivered via VoIP.

### SUMMARY

The present invention provides an improved inmate call monitoring system and method. The claims, and only the claims, define the invention.

The principles of the present disclosure provide a system and method for monitoring and controlling inmate telephone calls delivered via VoIP or other means. By using software to detect and monitor periods of silence during the conversation, the disclosed monitoring and control system can determine whether an unauthorized call connecting attempt has been made. When such a determination is made, the call can be terminated, recorded, or monitored by an operator, depending on the preference of the correctional facility and/or to whom the inmate has called.

In one aspect of the present disclosure, a method for managing and controlling telephone activity in a correctional facility is provided. The method comprises the steps of providing a first communicative connection between a caller and a recipient. The method further comprises the steps of delivering the conversation between the caller and the recipient over the first communicative connection and executing silence recognition software to identify a plurality of periods of conversation silence delivered over the first communicative connection. The method continues by comparing the periods of conversation silence with a silence threshold to determine whether the recipient is attempting to create an unauthorized call connection. Based on that comparison step, a detection response is executed.

It is an object of certain embodiments of the present disclosure is to provide an improved inmate call monitoring system and method.

Further forms, objects, features, aspects, benefits, advantages, and embodiments of the present invention will become apparent from a detailed description and drawings provided herewith.

### BRIEF DESCRIPTION OF THE DRAWINGS

FIG. 1 is an illustration of an exemplary system to monitor and control inmate calls in accordance with the principles of the present disclosure.

FIG. 2 is an illustration of another embodiment of a system to monitor and control inmate calls in accordance with the principles of the present disclosure.

FIG. 3 is a flow chart for the post-conversation call connecting determination according to one embodiment of the present disclosure.

FIG. 4 is a flow chart for the real-time call connecting determination according to one embodiment of the present disclosure.

FIG. 5 is a flow chart for the real-time call connecting determination according to another embodiment of the present disclosure.

FIG. 6 is a flow chart for the post-conversation call connecting determination according to a further embodiment of the present disclosure.

FIG. 7 is a flow chart for the post-conversation call connecting determination according to a further embodiment of the present disclosure.

FIG. 8 is a flow chart for the call connecting determination according to another embodiment of the present disclosure.

### DESCRIPTION OF THE SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

The language used in the claims is to only have its plain and ordinary meaning, except as may be explicitly defined herein. Such plain and ordinary meaning is inclusive of all consistent dictionary definitions from the most recently published Webster's dictionaries and Random House dictionaries.

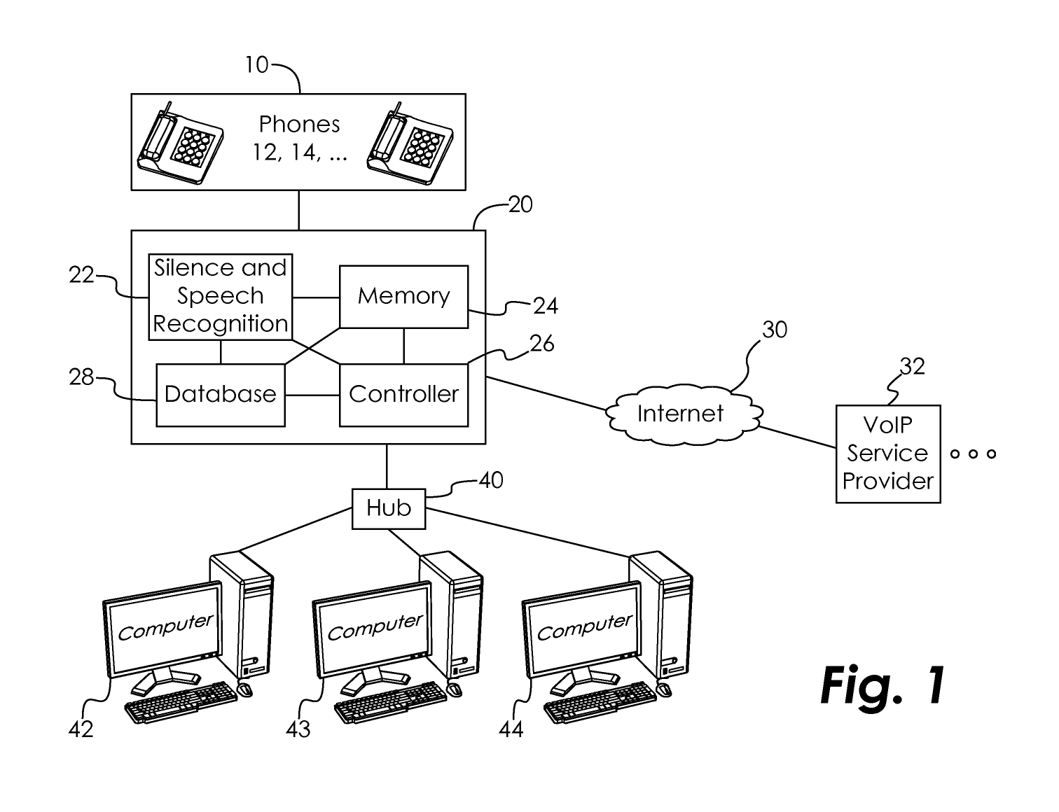

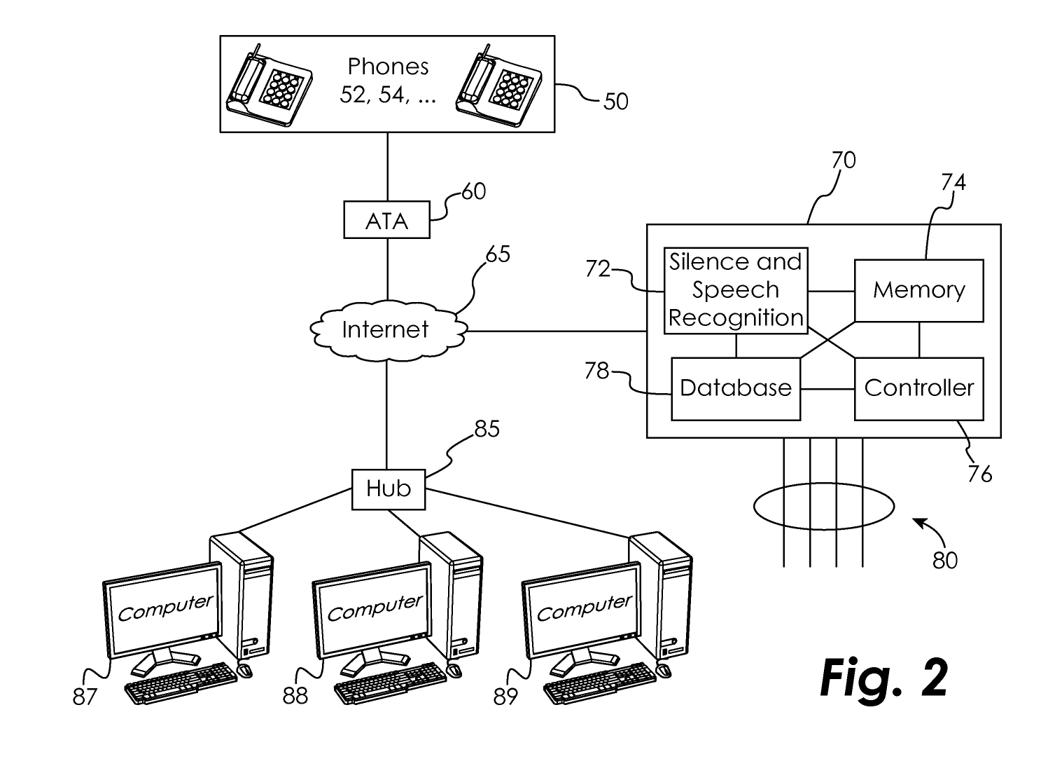

FIG. 1 is an illustrative embodiment of a disclosed system for monitoring and controlling inmate telephone calls originating from a telephone bank 10 within a correctional facility. Telephone bank 10 includes a plurality of individual inmate telephones 12, 14. A phone monitoring and control system 20 is communicatively and operationally connected to telephone bank 10. Monitoring and control system 20 is connected to the internet 30. Monitoring and control system 20 is constructed and arranged to monitor and control the delivery and receipt of communication signals between telephones 12, 14 and a VoIP service provider 32, which is connected to the internet 30. As appreciated by those of skill in the relevant art, VoIP service provider 32 has the capability of delivering the VoIP communications originating from the inmate telephones 12, 14 to either other VoIP devices via the internet or to standard, analog telephone devices via the PSTN. In some embodiments, system 20 may be at the same location as phones 12, 14. In other embodiments, system 20 may be remotely connected to phones 12, 14 by PSTN, the internet (see FIG. 2 embodiment), or other known communication means.

As illustrated, monitoring and control system 20 comprises a silence and speech recognition module 22, a memory 24, a controller 26, and a database 28. Each of these components is communicatively and operatively connected to one another. The silence and speech recognition module 22 comprises computer software designed to identify and spot silent portions of a conversation as well as the spoken words. As used throughout this application, conversation silence is understood to encompass a variety of conditions suggesting that no substantive communication or conversation is occurring, such as when no sound (or no sound exceeding a low audible level) is being delivered over a communication line or when no words are recognized and detected during a portion of the conversation. Silence and speech recognition module 22 may exist as a single module (as depicted) or may in other embodiments be separate and distinct components. The silence and speech recognition module 22 can identify periods of silence and/or words in either a real-time fashion, i.e., during the on-going call, or in a post-processing fashion, i.e., communications stored into memory 24. Examples of the software utilized by silence and speech recognition module 22 is the Key Word Spotting product available from Natural Speech Communication Ltd having headquarters in Rishon Lezion, Israel, and the CMU Sphinx speech recognition engines available at http://cmusphinx.sourceforge.net/, a project by Carnegie Mellon University in Pittsburg, Pa.

Memory 24 is constructed and arranged to optionally store the digital voice communications received from and delivered to inmate telephones 12, 14. In some embodiments, memory 24 is a standard memory component, such as, but not limited to, a hard disk drive, RAM, or ROM, or any other known electrical storage device.

Controller 26 is constructed and arranged to dictate and monitor the operations of monitoring and control system 20 and execute an appropriate detection response if it is determined that unauthorized call connecting has been attempted. As used herein, unauthorized call connecting is understood to mean call bridging, call forwarding, and/or any other known means for creating a communicative connection between one party of a telephone call and a third party to the telephone call. Long periods of call silence or a high ratio of call silence time to call conversation time may indicate that one party is attempting, or has attempted, to initiate unauthorized call connecting with a third party.

Controller 26 controls the recording of the digital voice communications received from and delivered to inmate telephones 12, 14 onto memory 24. Controller 26 may instruct the memory to record an entire phone call, a portion of the phone call, or to act as a memory buffer, recording a predetermined portion of the call before a triggering period of conversation silence is recognized by the silence and speech recognition module 22. The controller 26 may also be operational to terminate the connection between an inmate telephone 12, 14 and an outside phone line. Additionally, the controller may be operational to decide when the speech recognition module 22 is to be executed.

Database 28 stores and maintains silence thresholds which are indicative of a call connecting attempt. The silence thresholds may be a defined length of time for a single period of silence and/or a value of a relationship between active conversation time to total call time. As used herein, total call time is understood to mean the overall length of time of the conversation, including periods of silence. As used herein, active conversation time is understood to mean the time of the conversation in which recognizable words are being communicated, i.e., the overall call time minus periods of silence. By comparing the active conversation time to the total call time, an evaluation can be made whether the active conversation time is too low. The value of the relationship between the active conversation time to the total call time may be, but is not limited to, the difference or the ratio of the two times.

As illustrated, a single database 28 is provided within monitoring and control system 20. In such a situation, the database 28 is constructed and arranged as a global database against which all periods of silence in all inmate telephone conversations are evaluated. In other embodiments, the database 28 may be constructed and arranged as separate databases specific to each individual inmate.

Monitoring and control system 20 is also communicatively coupled to a hub 40. Hub 40 is configured to communicatively and operationally connect correctional facility computers 42, 43, 44 with monitoring and control system 20. When system 20 identifies an unauthorized call connecting attempt, system 20 is constructed and arranged to notify the correctional facility computers 42, 43, 44 via email, audio and/or visual indication. In turn, computers 42, 43, 44 can access memory 24 to allow the computer operators to listen to the recorded phone calls. In some embodiments, the operators of computers 42, 43, 44 can listen to the telephone conversations live. The correctional facility computers 42, 43, 44 may also have the capability of updating database 28 with additional names, words or numbers which will flag attempted and unauthorized call connecting. While three correctional facility computers are depicted, other embodiments of the present disclosure may comprise fewer or more than three correctional facility computers.

While silence and speech recognition module 22, memory 24, controller 26, and database 28 are depicted as residing within the same location, it is within the scope of the present disclosure that the components of system 20 do not need to be physically proximate. For example, the database 28 may be physically stored remotely from the other components and accessed via the internet. Monitoring and control system 20 and VoIP service provider 32 are connected to the internet 30 through known techniques.

FIG. 2 is a further illustrative embodiment of a disclosed system for monitoring and controlling inmate telephone calls originating from a telephone bank 50 within a correctional facility. Telephone bank 50 includes a plurality of individual inmate telephones 52, 54. As illustrated, the individual telephones 52, 54 of inmate phone bank 50 are connected to an analog telephone adaptor (ATA) 60, which is communicatively connected to the internet 65. ATA 60 converts the speech spoken into inmate telephones 52, 54 from an analog signal into digital format and compresses/translates the signal into internet protocol for transmission over the internet 65. Conversely, the ATA 60 is designed to convert a communication received in digital format into an analog signal to be heard by the inmate using telephones 52, 54.

A monitoring and control system 70 is communicatively and operationally connected to the internet 65. Monitoring and control system 70 is constructed and arranged to receive the VoIP communication from ATA 60 and relay that communication to outside phone lines 80, and vice versa. The telephone communications sent to and received from outside phone lines 80 may be in VoIP or standard, analog format.

Like the monitoring and control system 20 of FIG. 1, monitoring and control system 70 comprises a silence and speech recognition module 72, a memory 74, a controller 76, and a database 78. For the sake of brevity, the components of system 20 and system 70 are functionally equivalent and reference is made to the above discussion as to the purpose and operation of those components. Any difference between the two systems is discussed below.

A hub 85 is configured to communicatively and operationally connect correctional facility computers 87, 88 and 89 with the internet 65. When system 70 identifies an unauthorized call connecting attempt, system 70 is constructed and arranged to notify the correctional facility computers 87, 88, 89 through a notification sent via the internet 65. Through that connection to the internet 65, computers 87, 88, 89 can access memory 74 to allow the computer operators to listen to the recorded phone calls. In other embodiments, the operators of computers 87, 88, 89 can listen to the telephone conversations live. Similarly, the correctional facility has the capability of updating silence thresholds which will flag attempted and unauthorized call connecting. In a broader sense, the components of the monitoring and control system 70 may be configured remotely by the correctional facility computers 87, 88, 89 by known techniques, including, but not limited to, GUI or CLI-type interfaces.

ATA 60, monitoring and control system 70, and hub 85 are connected to the internet 65 through known techniques. As depicted in FIG. 2, the monitoring and control system 70 may be located separate from the correctional facility.

ATA 60 may be used with the telephones to convert the analog communications into a digital format. In other embodiments, the individual telephones are VoIP devices thereby eliminating the need for an ATA within the system.

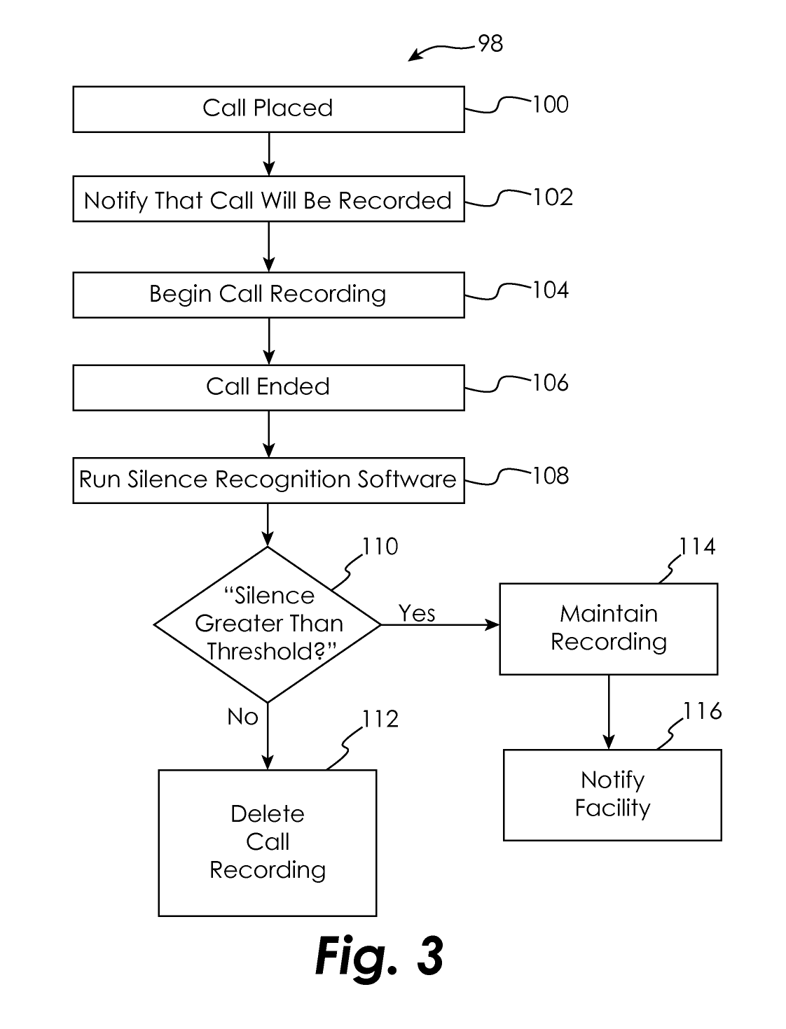

FIG. 3 is a flow chart of an exemplary process 98 for system and method operation for monitoring and controlling inmate telephone calls. The process 98 starts at step 100 when an inmate within the correctional facility places a phone call. Pursuant to some of the embodiments of the present disclosure, the phone calls are delivered and received over the internet via VoIP services. Once the phone call is placed, at least one of caller and recipient are optionally notified that the call will be recorded (step 102). At step 104, the conversation between the inmate caller and the outside recipient is recorded in digital form. At step 106, the telephone call is completed.

At some time later, the silence and speech recognition software is run (step 108). As previously discussed, the silence and speech recognition software identifies periods during the conversation in which no substantive communication is occurring. Again, as but two examples, such instances may be when no sound (or no sound exceeding a low audible level) is delivered over a communication line or when no words are recognized and detected. As the periods of silence are identified, they are compared to a silence threshold. The silence thresholds are determined by the correctional facility or other source as the amount or periods of silence within a conversation which are indicative of an unauthorized call connecting attempt.

For each period of conversation silence, the control and monitoring system will determine if the period of silence is greater than a silence threshold (decision step 110). If each period of silence is less than the silence threshold, then the stored call recording may be deleted (step 112). If at least one period of silence is greater than the silence threshold, then that is indicative of an unauthorized call connecting attempt and a detection response may be executed. At step 114, the phone call record is maintained. At step 116, the correctional facility is notified of the possible unauthorized call connecting attempt.

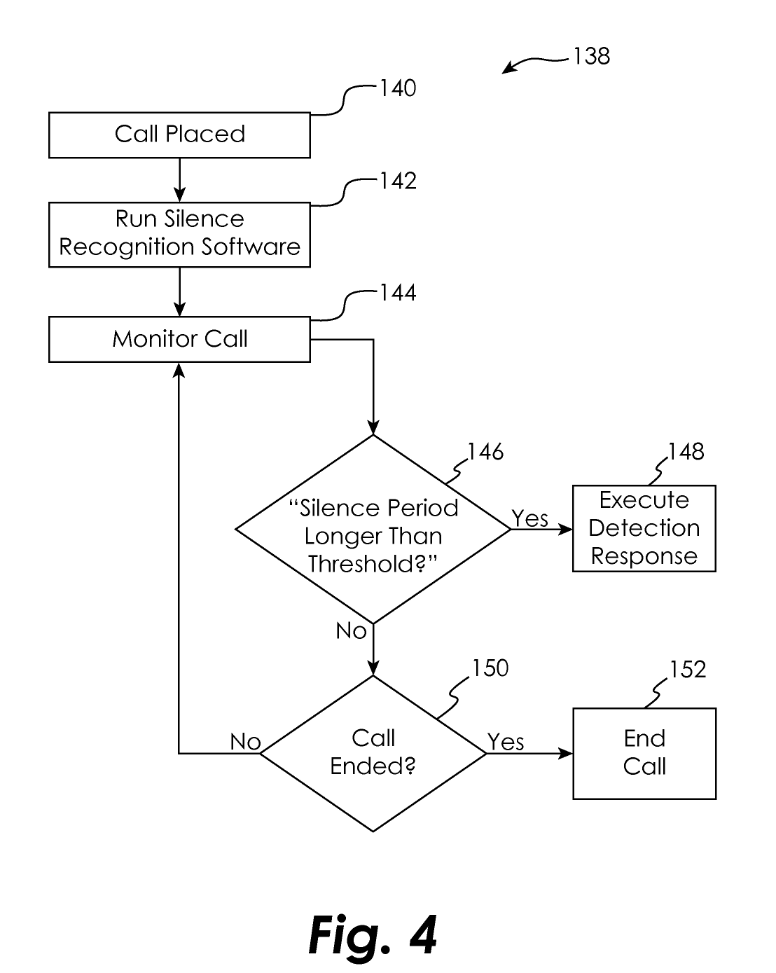

FIG. 4 is a flow chart of an exemplary process 138 for system and method operation for monitoring and controlling inmate telephone calls. The process 138 starts at step 140 when an inmate within the correctional facility places a phone call. In this embodiment, the silence and speech recognition software is executed from the start of the conversation between the inmate caller and the outside recipient (step 142). The silence and speech recognition software identifies periods of conversation silence occurring between the inmate caller and the outside recipient and allows the call to be monitored (step 144). As the periods of conversation silence are identified, they are compared to a silence threshold.

That comparison determines if the period of conversation silence is greater than the silence threshold (decision step 146). If a period of silence is found to be greater than the silence threshold, then that is indicative of an unauthorized call connecting attempt and a detection response may be executed (step 148). As used throughout this application, the detection response is understood to be any desired action the correctional facility determines to take including, but not limited to, terminating the phone call, alerting the correctional facility personnel of the unauthorized call connecting attempt, archiving a recording of the conversation, routing the call to a live operator, disabling the inmate telephone (i.e., the mouthpiece and/or earpiece) while the possible unauthorized call connecting is being investigated, flagging the call as potential fraud, blocking future calls to be placed to that number by the inmate, etc. For the call blocking, the monitoring and control system may optionally prohibit a particular inmate from placing a call to the telephone number in which an unauthorized call connecting attempt has previously been identified. The call blocking may be applied to an inmate for a particular phone number for a specified period of time or permanently.

If the period of silence is found to be less than the silence threshold, then the monitoring and control system determines if the telephone call has been ended (decision step 150). If the call has not been ended, then the conversation will continue to be monitored (step 144). If the call has been ended, the connection between the caller and the recipient is terminated (step 152).

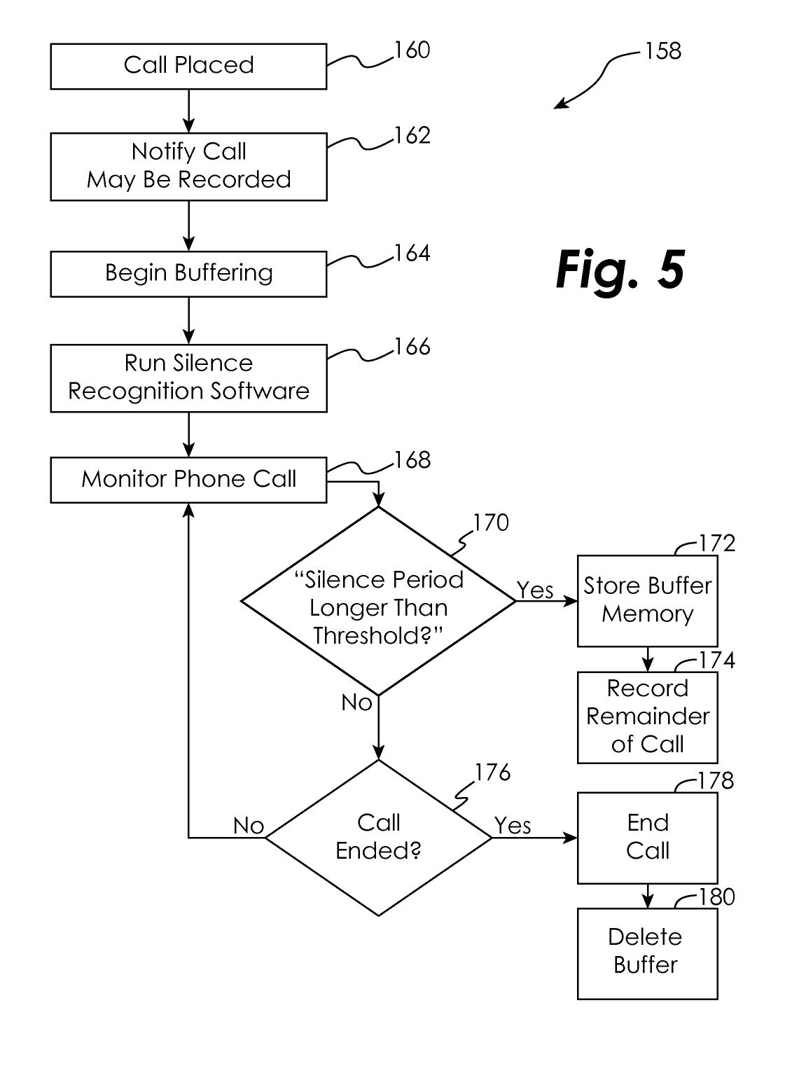

FIG. 5 is a flow chart of a further exemplary process 158 for system and method operation for monitoring and controlling inmate telephone calls. The process 158 starts at step 160 when an inmate within the correctional facility places a phone call. Once the phone call is placed, the caller and recipient are optionally notified that the call will be recorded (step 162). At step 164, a buffer memory of the conversation between the inmate caller and the outside caller is maintained in digital form. As used in the present disclosure, the buffer memory is a temporary, digital or analog record of a portion of the conversation between the inmate caller and the outside recipient. At step 166, the silence and speech recognition software is run.

The silence and speech recognition software identifies periods of conversation silence occurring between the inmate caller and the outside recipient (step 168). As the periods of conversation silence are identified, they are compared to a silence threshold. That comparison will determine if the period of conversation silence is greater than the silence threshold (decision step 170). If a period of silence is found to be greater than the silence threshold, then that is indicative of an unauthorized call connecting attempt and a detection response may be executed. Therefore, at step 172, the buffer memory is stored. Further, at step 174, the remainder of the phone call is optionally recorded. The buffer memory and the recording of the remainder of the phone call constitute a complete call record.

If no periods of conversation silence are identified during the phone conversation which exceed the silence threshold, then the monitoring and control system determines if the telephone call has been ended (decision step 176). If the call has not been ended, then the call will continue to be monitored (step 168). If the call has been ended, the connection between the caller and the recipient is terminated (step 178) and the buffer may optionally be deleted (step 180).

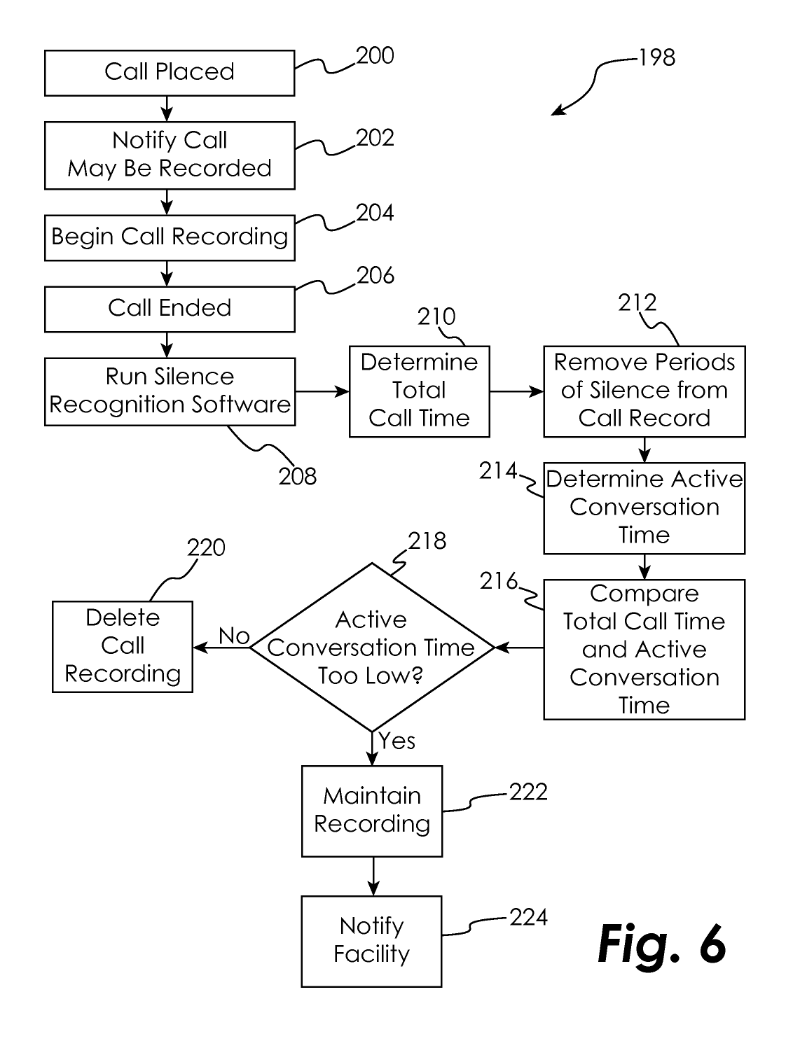

FIG. 6 is a flow chart of an exemplary process 198 for system and method operation for monitoring and controlling inmate telephone calls. The process 198 starts at step 200 when an inmate within the correctional facility places a phone call. Once the phone call is placed, at least one of caller and recipient are optionally notified that the call will be recorded (step 202). At step 204, the conversation between the inmate caller and the outside recipient is recorded in digital form. At step 206, the telephone call is completed.

At some time later, the silence and speech recognition software is run (step 208). As previously discussed, the silence and speech recognition software identifies periods during the conversation in which no substantive communication is occurring. At step 210, the total call time is determined. The total call time is the overall length of time of the entire phone call, including any periods of silence. Then, the monitoring and control system removes the identified periods of conversation silence from the call record (step 212) and determines the active conversation time of the call (step 214). Active conversation time is the total time of the conversation in which recognizable words are being communicated. At step 216, the total call time and the active conversation time are compared. By comparing the active conversation time to the total call time, an evaluation can be made whether the active conversation time is too low (step 218). This evaluation can be made in a variety of ways, such as, but not limited to, by looking at the difference between the two times or the ratio of the two times (i.e., ratio of active conversation time to total call time).

If the active conversation time is found to not be too low, then the stored call recording may be deleted (step 220). If the active conversation time is found to be too low, then that is indicative of an unauthorized call connecting attempt and a detection response may be executed. At step 222, the phone call record is maintained. At step 224, the correctional facility is notified of the possible unauthorized call connecting attempt.

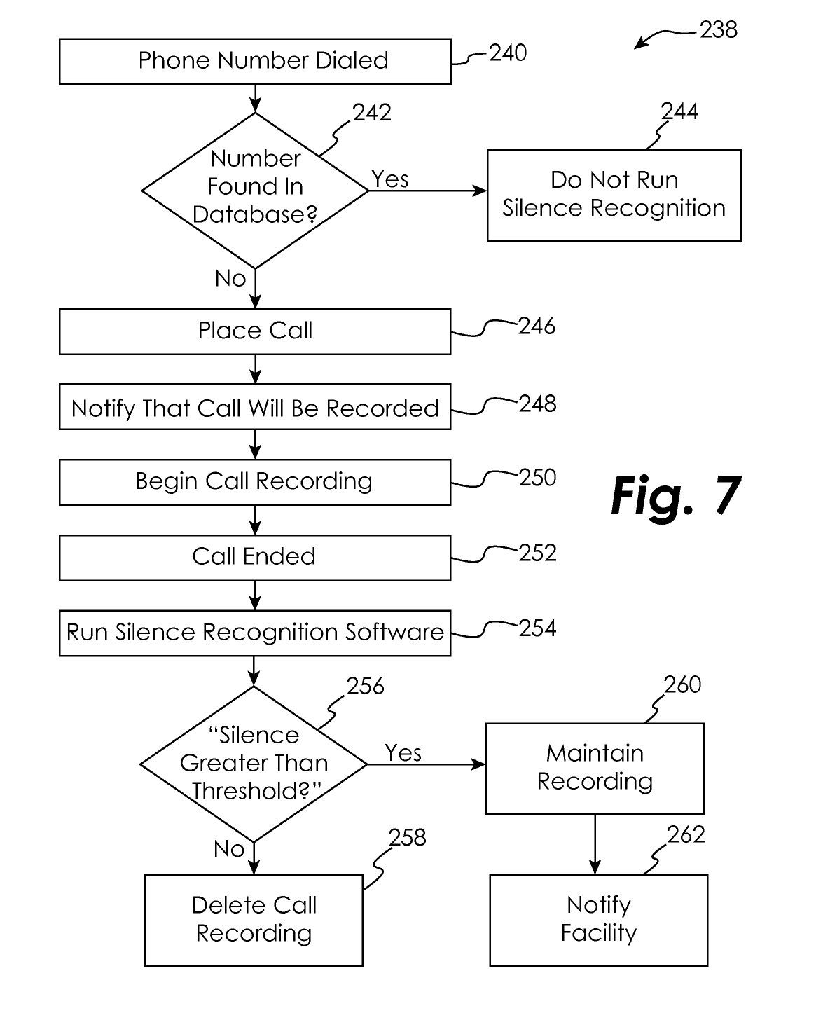

FIG. 7 is a flow chart of yet another exemplary process 238 of system and method operation for monitoring and controlling inmate telephone calls. Due to the attorney-client privilege, the correctional facility may choose to not monitor a telephone conversation between an inmate and his/her attorney. For that reason, the system may include a database which stores the telephone numbers of each inmate's attorney. Accordingly, process 238 starts at step 240 when an inmate within the correctional facility dials the desired phone number to be called. Once the phone number is dialed, the database is searched to determine if that telephone number is associated with the inmate's attorney (decision step 242). If the dialed telephone number is found in the database, then the silence and speech recognition software is not run (step 244). The telephone call is still placed, but the conversation is not recorded or monitored in any way.

If the dialed telephone number is not found in the database, the phone call is placed (step 246) and at least one of the caller and recipient are notified that the call will be recorded (step 248). At step 250, the conversation between the inmate caller and the outside recipient is recorded in digital form. At step 252, the telephone call is completed.

At some time later, the silence and speech recognition software is run (step 254) and the control and monitoring system will determine if the identified periods of silence are greater than the silence threshold (decision step 256). If no periods of conversation silence are identified during the phone conversation which exceed the silence threshold, then the call recording may be deleted (step 258). If at least one period of conversation silence is identified which exceeds the silence threshold, then that is indicative of an unauthorized call connecting attempt and a detection response may be executed. At step 260, the phone call record is maintained. At step 262, the correctional facility is notified of the possible unauthorized call connecting attempt.

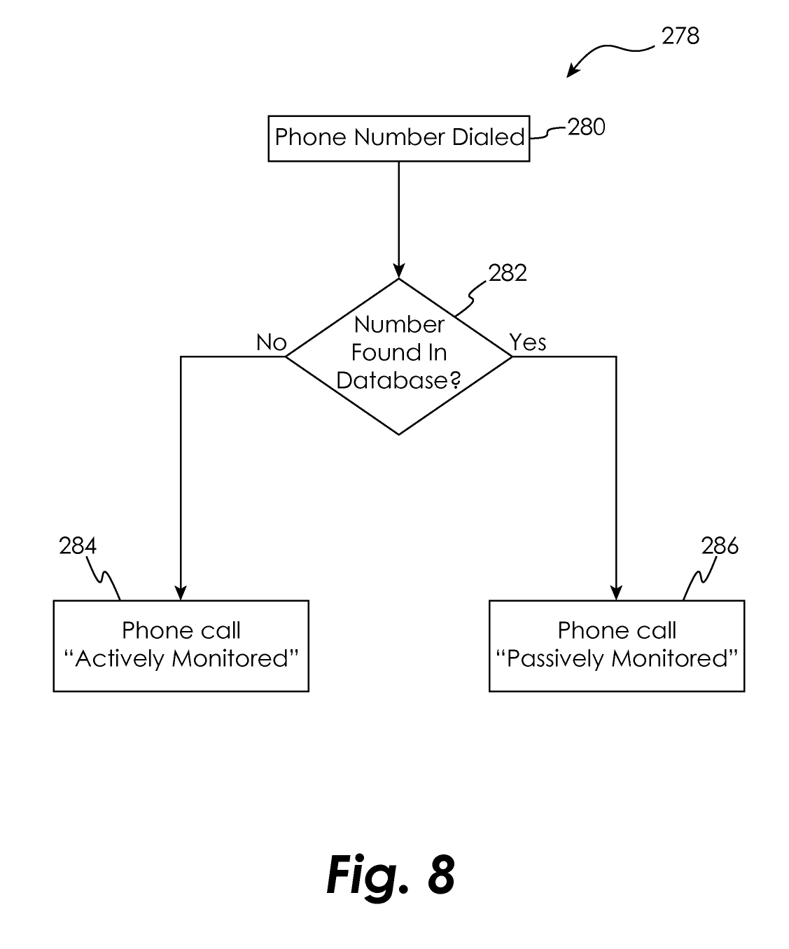

FIG. 8 is a flow chart of a further exemplary process 278 for system and method operation for monitoring and controlling inmate telephone calls. As noted above, a correctional facility may choose to not “actively monitor” a telephone conversation between an inmate and his/her attorney due to legal concerns. For the purposes of the present disclosure, the term “actively monitor” is intended to mean that the conversation or a recording of the conversation is capable of being listened to by an individual outside of the attorney-inmate relationship.

The system and method of the present disclosure allows the attorney-client conversation to be “passively monitored”. For the purposes of the present disclosure, the term “passively monitor” is intended to mean that conversation is not capable of being listened to by an individual outside of the attorney-inmate relationship and no recording of that conversation is made or maintained. However, the conversation is monitored solely by the silence and speech recognition software to identify periods of conversation silence. In turn, the monitoring and control system is executed to determine if either a single period of conversation silence or the total amount of conversation silence is larger than a predetermined silence threshold which would indicate that an unauthorized call connecting attempt has been made. The monitoring and control system can therefore terminate the phone call to thwart such a connecting attempt, or other appropriate detection response.

Such a process is depicted in FIG. 8. Process 278 starts at step 280 when an inmate within the correctional facility dials the desired phone number. Once the phone number is dialed, a database is searched to determine if that telephone number is associated with the inmate's attorney (decision step 282). If the dialed telephone number is not found in the database, then conversation between the inmate and the recipient may be actively monitored (step 284). In one embodiment, the active monitoring is performed pursuant to process 158 as depicted in FIG. 5. In another embodiment, the phone call may be actively monitored by an individual actively listening to the conversation between the inmate and the outside recipient. Other forms of active monitoring may also be incorporated.

If the dialed telephone number is found in the database, the conversation between the inmate and the outside recipient is passively monitored (step 286). In one embodiment, the passive monitoring is performed pursuant to process 138 as depicted in FIG. 4. As depicted in FIG. 4, the telephone call is terminated if the monitoring and control system determines that an unauthorized call connecting attempt has been made. Therefore, no recording of the conversation between the attorney-inmate has been made. Other forms of passive monitoring may also be incorporated.

It will be appreciated by those skilled in the art that all of the presently disclosed embodiments may also be implemented for calls originating outside of the correctional facility and placed to an inmate. It will also be appreciated by those skilled in the art that the control and monitoring systems presently disclosed would be equally applicable to phone calls being delivered primarily over a PSTN rather than a VoIP communication system. In some embodiments, the control and monitoring system can tap into the analog phone signal and convert the communications into a digital format, at which point the various components of the control and monitoring system may be implemented as disclosed herein.

While the invention has been illustrated and described in detail in the drawings and foregoing description, the same is to be considered as illustrative and not restrictive in character, it being understood that only the preferred embodiments have been shown and described and that all changes and modifications that come within the spirit of the invention are desired to be protected. It is also contemplated that structures and features embodied in the present examples can be altered, rearranged, substituted, deleted, duplicated, combined, or added to each other. The articles “the”, “a” and “an” are not necessarily limited to mean only one, but rather are inclusive and open ended so as to include, optionally, multiple such elements.

What is claimed is:

1. A method for managing and controlling telephone activity within a correctional facility, the method comprising the steps of:
(a) providing a first communicative connection between a caller and a recipient;
(b) delivering a conversation between the caller and the recipient over the first communicative connection;
(c) executing a silence recognition software to identify a plurality of periods of conversation silence delivered over the first communicative connection;
(d) comparing the periods of conversation silence with a silence threshold to determine whether the recipient is attempting to create an unauthorized call connection;
and (e) executing a detection response based on the comparing step.

2. The method of claim 1, wherein the unauthorized call connection is the bridging of the first communicative connection with a second communicative connection.

3. The method of claim 1, wherein the detection response comprises terminating the first communicative connection.

4. The method of claim 1, wherein the detection response comprises blocking a future communicative connection from being provided between the caller and the recipient.

5. The method of claim 1, wherein the detection response comprises notifying the correctional facility that unauthorized call connecting has been attempted.

6. The method of claim 1, wherein the detection response comprises routing the conversation to a live operator.

7. The method of claim 1, wherein the detection response comprises disabling a telephone used by the caller while the attempted and unauthorized call connecting is investigated.

8. The method of claim 1, further comprising the step of providing a database of attorney phone numbers, wherein the detection response comprises recording the conversation words into a call record memory unless the telephone number of the recipient is in the database of attorney phone numbers.

9. The method of claim 1, wherein the caller is inside the correctional facility.

10. The method of claim 1, wherein the conversation between the caller and the recipient is delivered over the first communicative connection via voice over internet protocol.

11. A method for managing telephone activity, the method comprising the steps of:
(a) providing a first communicative connection between a caller and a recipient;
(b) delivering a conversation between the caller and the recipient over the first communicative connection;
(c) executing a silence recognition software to identify a plurality of conversation silence periods transmitted over the first communicative connection;
(d) storing the conversation into a temporary memory;
(e) comparing the conversation silence periods with a silence threshold to determine whether the recipient is attempting to create an unauthorized call connection; and
(f) executing a detection response based on the comparing step.

12. The method of claim 11, wherein the caller is inside a correctional facility.

13. The method of claim 12, wherein the conversation between the caller and the recipient is delivered over the first communicative connection via voice over internet protocol.

14. The method of claim 13, wherein the detection response comprises storing the conversation in the temporary memory as a call record memory.

15. The method of claim 14, wherein the detection response further comprises recording the remainder of the conversation into the call record memory.

16. The method of claim 15, wherein the detection response further comprises notifying the correctional facility that unauthorized call connecting has been attempted.

17. The method of claim 13, wherein the detection response comprises routing the conversation to a live operator.

18. The method of claim 13, wherein the detection response comprises disabling a telephone used by the caller while the attempted and unauthorized call connecting is investigated.

19. The method of claim 13, wherein the unauthorized call connection is the bridging of the first communicative connection with a second communicative connection.

20. The method of claim 13 further comprising the step of alerting the caller and the recipient that the communications over the first communicative connection may be recorded.

21. A system for managing telephone activity within a correctional facility, the system comprising:
a communicative connection between a caller and a recipient constructed and arranged to deliver a conversation between the caller and the recipient; and
a control and monitor system constructed and arranged to receive the conversation, the control and monitor system comprising:
a first database of silence threshold values;
a silence recognition module constructed and arranged to identify a plurality of periods of conversation silence delivered over the communicative connection, the silence recognition module is further constructed and arranged to compare the periods of conversation silence with the database of silence threshold values to determine whether an unauthorized call connecting attempt has been made.

22. The system of claim 21, wherein the control and monitoring system further comprises a memory constructed and arranged to store the conversation delivered over the communicative connection.

23. The system of claim 22, wherein the control and monitoring system further comprises a controller constructed and arranged to execute a detection response when the control and monitoring system determines that an unauthorized call connecting attempt has been made.

24. The system of claim 23, wherein the detection response comprises terminating the communicative connection.

25. The system of claim 23, wherein the detection response comprises recording the conversation into the memory.

26. The system of claim 23, wherein the detection response comprises routing the conversation to a live operator.

27. The system of claim 23, wherein the detection response comprises disabling a telephone used by the caller while an attempted and unauthorized call connecting is investigated.

28. The system of claim 23 further comprising a correctional facility computer in communicative connection with the control and monitoring system, wherein the detection response comprises providing a notification to the correctional facility computer that unauthorized call connecting has been attempted.

29. The system of claim 23 further comprising a second database of attorney phone numbers, wherein the detection response comprises recording the conversation words into a call record memory unless the telephone number of the recipient is in the database of attorney phone numbers.

30. The system of claim 21, wherein the communicative connection is constructed and arranged to deliver communications between caller and the recipient via voice over internet protocol (VoIP).

31. The system of claim 21, wherein the caller is inside the correctional facility.

32. A method for managing and controlling telephone activity within a correctional facility, the method comprising the steps of:
(a) providing a first communicative connection between a caller and a recipient;
(b) delivering a conversation between the caller and the recipient over the first communicative connection;
(c) storing the conversation into a memory;
(d) determining a total call time for the conversation;
(e) executing a silence recognition software to identify a plurality of periods of silence which occurred during the conversation;
(f) determining an active conversation time;
(g) evaluating a relationship of the active conversation time and the total call time to determine whether the recipient has attempted to create an unauthorized call connection; and
(h) executing a detection response based on the evaluating step.

33. The method of claim 32, wherein the unauthorized call connection is the bridging of the first communicative connection with a second communicative connection.

34. The method of claim 32, wherein the caller is inside the correctional facility.

35. The method of claim 32, wherein the conversation between the caller and the recipient is delivered over the first communicative connection via voice over internet protocol.

36. The method of claim 32, wherein the evaluating step comprises determining a difference between the total call time and the active conversation time.

37. The method of claim 32, wherein the evaluating step comprises determining a ratio of the active conversation time to the total conversation time.

38. The method of claim 32, wherein the evaluating step comprises determining a ratio of the total conversation time to the active conversation time.

39. The method of claim 32, wherein the active conversation time is equal to the total call time minus the periods of silence.

40. A method for managing and controlling telephone activity within a correctional facility, the method comprising the steps of:
(a) providing a first communicative connection between a caller and a recipient;
(b) delivering a conversation between the caller and the recipient over the first communicative connection;
(c) recording the conversation into a memory, the recording having a first length;
(d) determining a total call time for the conversation equal to the first length;
(e) executing a silence recognition software to identify a plurality of periods of silence which occurred during the conversation;
(f) removing the periods of silence from the recording of conversation, the remaining length of the recording having a second length;
(g) determining an active conversation time equal to the second length;
(h) evaluating a relationship of the active conversation time and the total call time to determine whether the recipient has attempted to create an unauthorized call connection; and
(i) executing a detection response based on the evaluating step.

41. The method of claim 40, wherein the unauthorized call connection is the bridging of the first communicative connection with a second communicative connection.

42. The method of claim 40, wherein the caller is inside the correctional facility.

43. The method of claim 40, wherein the conversation between the caller and the recipient is delivered over the first communicative connection via voice over internet protocol.

44. The method of claim 40, wherein the evaluating step comprises determining a difference between the total call time and the active conversation time.

45. The method of claim 40, wherein the evaluating step comprises determining a ratio of the active conversation time to the total conversation time.

46. The method of claim 40, wherein the evaluating step comprises determining a ratio of the total conversation time to the active conversation time.
